(19) United States
(12) Patent Application Publication
(10) Pub. No.: US 2026/0095807 A1
(43) Pub. Date: Apr. 2, 2026

(54) AIOT – METHODS FOR SUPPORTING QOS WITH AIOT OPERATIONS

(71) Applicant: InterDigital Patent Holdings, Inc., Wilmington, DE (US)

(72) Inventors: Jongwoo Hong, New York, NY (US); Martino Freda, Laval (CA); Erdem Bala, East Meadow, NY (US); Paul Marinier, Brossard (CA); Guanzhou Wang, Brossard (CA); Patrick Tooher, Montreal (CA)

(73) Assignee: InterDigital Patent Holdings, Inc., Wilmington, DE (US)

(21) Appl. No.: 18/902,585

(22) Filed: Sep. 30, 2024

(51) Int. Cl. H04W 28/02; H04L 67/12

(52) U.S. Cl. CPC H04W 28/0268; H04L 67/12

(57) ABSTRACT

Method are disclosed for a wireless transmit receive unit (WTRU) including receiving configuration information including a plurality of access stratum (AS) configurations, where each AS configuration is associated with a quality of service (QoS) level specific to an ambient internet of things (AIoT) operation. The WTRU receives, on a Uu bearer from the base station, data for at least one AIoT device and based on the Uu bearer of the received data, the WTRU determines a select AS configuration with associated QoS level from the plurality of AS configurations. The WTRU transmits the received data to the AIoT device(s) using resource and transmission parameters of the select AS configuration with associated QoS level. Additional embodiments are disclosed.

### BACKGROUND

Ambient Internet of Things (AIoT) is a subject of study based on the increased popularity of IoT. In recent years, IoT has attracted significant attention in the wireless communication world and more ‘things’ are expected to be interconnected for improving productivity, efficiency and increasing comforts of life. Further reduction of size, complexity and power consumption of IoT devices can enable the deployment of tens or even hundreds of billions of IoT devices for various applications and will provide added value across the entire value chain. It is impossible to power all the IoT devices by batteries that require manual replacing or recharging, which leads to high maintenance cost, serious environmental issues and even safety hazards for some use cases, e.g., wireless sensors used in electric power and petroleum industries.

Most of the existing wireless communication devices are powered by battery that needs to be replaced or recharged manually. The automation and digitalization of various industries open numbers of new markets requiring new IoT technologies of supporting battery-less devices with no energy storage capability or devices with energy storage that do not need to be replaced or recharged manually. The form factor of such devices must be reasonably small to convey the validity of target use cases.

An example type of application is asset identification, which presently has to resort mainly to barcode and radio frequency identification (RFID) in most industries. The main advantage of these two technologies is the ultra-low complexity and small form factor of the tags. However, the limited reading range of a few meters usually requires handheld scanning which leads to labor intensive and time-consuming operations. Alternatively, RFID portals or gates may be used which leads to costly deployments. Moreover, the lack of an interference management scheme results in severe interference between RFID readers and capacity problems, especially in case of dense deployment, where it is challenging to support large-scale networks with seamless coverage for RFID.

Future AIoT services that have been proposed may need to differentiate and/or prioritize AIoT operations with different quality of service (QoS) requirements (i.e., completion time). For example, a user equipment (UE) may need to provide different QoS levels for the same inventory procedure. Two distinct inventory procedures may be targeted with different completion times based on the requested number of devices or requested services, and/or (re-)transmission for the specific device.

Since AIoT transmission between a UE and an AIoT device utilizes Uu resource with sharing UEs in new radio (NR), a base station, e.g., a gNB, should control the amounts of resources for AIoT devices by considering the QoS requirement of the AIoT service, along with other Uu services for other NR UEs. However, in a non-access stratum (NAS)-based model, a QoS level of AIoT data is decided by core network (CN), and details for an AIoT inventory procedure (e.g., latency requirement) may not be known by the gNB. Accordingly, the gNB cannot configure appropriate Uu resources for AIoT operations according to the QoS level requested by the CN. Moreover, if the gNB configures possible amounts of resources based on QoS requirement of the AIoT service in advance, additional Uu resources may be wasted since the gNB does not know when the AIoT data with a QoS requirement may not be triggered and/or how often it would be triggered. Accordingly, solutions are needed for AIoT data with QoS requirements. Specifically, upon arrival of AIoT data from the CN, solutions are needed for the UE to know the QoS of the AIoT data and a corresponding the AS configuration (e.g., resources/transmission (TX) parameters) for reader-to-device (R2D)/device-to-reader (D2R) transmissions for the AIoT interface. Additionally, solutions are need to determine what information needs to be configured with a UE for supporting QoS and/or to map/determine an AS configuration with QoS levels of arrived AIoT data.

### SUMMARY

In a first aspect of the disclosed embodiments, one or more solutions are provided where, upon receiving an AIoT data from a network (e.g., CN), a UE, alternatively referred to herein as a wireless transmit receive unit (WTRU), determines AIoT resource and transmission parameters with a QoS level based on the configured bearer and/or priority associated the received AIoT data.

As an example, a method for use by a wireless transmit receive unit (WTRU) may include: receiving, from a base station, configuration information including a plurality of access stratum (AS) configurations for using AS layers (e.g., PHY/MAC/RRC layer), where each AS configuration is associated with a quality of service (QoS) level/profile specific to an ambient internet of things (AIoT) operation. The WTRU receives, on a Uu bearer from the base station, data for at least one AIoT device and based on the Uu bearer of the received data, the WTRU determines a select AS configuration with associated QoS level from the plurality of AS configurations. The WTRU then transmits the received data to the at least one AIoT device using resource and transmission parameters of the select AS configuration with associated QoS level.

In certain aspects, the configuration information includes a mapping of one or more Uu bearers for each AS configuration and associated QoS level specific to each AIoT operation. In other aspects, the configuration information includes an indication of one or more dedicated Uu bearers associated with a respective priority of the received data. In an example, the respective priority of the received data is associated with resource and transmission parameters for a specific AIoT operation and based on at least one of: an amount of dedicated Uu resource of the received data, an amount of access occasions for the at least one AIoT device, a number of retransmissions for the at least one AIoT device, a maximum power for transmitting or retransmitting to the at least one AIoT device, or a maximum or minimum reader-to-device (R2D) waiting time or device-to-reader (D2R) waiting time for subsequent message transmission or reception.

In another aspect, prior to receiving the configuration information, the WTRU receives, via the base station, a message from a core network (CN) for an AIoT service request with requested QoS profiles including one or more of: an association of the AIoT service request with one or more QoS profiles, where each QoS profile is associated with a packet delay budget of an AIoT interface or the AIoT service request is associated with one or more device IDs. The WTRU sends, to the base station, the one or more QoS profiles for an inventory procedure or a command procedure for the at least one AIoT device based on the received message from the CN.

In another example aspect, subsequent to receiving the configuration information, the WTRU reports to the base station, the select AS configuration to activate with associated QoS level determined by the WTRU. In another example aspect, the WTRU reports completion of the AIoT operation with the select AS configuration after transmitting the received data to the AIoT device(s) or receiving a response from the AIoT device to transmitting the data.

In a second aspect of the disclosed embodiments, one or more solutions are provided where, upon receiving the AIoT data with an associated QoS level/profile, a WTRU determines to transmit an uplink (UL) signal to activate/receive an AS configuration for AIoT operation based on the QoS levels.

As an example, a method for use by a WTRU may include receiving, from a core network (CN) via a base station, a message for an AIoT service request to perform one or more AIoT operations with one or more requested quality of service (QoS) profiles. The WTRU may receive, from the base station, configuration information including a list of uplink (UL) signals, a list of access stratum (AS) configurations each associated with a QoS level associated with a QoS profile specific to each of the one or more AIoT operations and a mapping of the list of UL signals to request a respective AS configuration. Upon receiving, from the CN via the base station, data with a QoS profile for an AIoT device for performing an AIoT operation the WTRU determines a select AS configuration and a corresponding UL signal from the mapping and sends, to the base station, the corresponding UL signal to request and activate the select AS configuration. In response to sending the corresponding UL signal, the WTRU receives, from the base station, the select AS configuration for performing the AIoT operation and sends, to the AIoT device, the received data with the QoS level for performing the AIoT operation.

In certain aspects, the AIoT operation is one of an inventory procedure or a command procedure with the at least one AIoT device. In certain aspects, he mapping of the list of UL signals to request/activate the respective AS configuration includes signaling for one of a scheduling request (SR), uplink control information (UCI), buffer status report (BSR), configured grant (CG) or radio resource control (RRC) message and an associated AS configuration. In other examples, the mapping of the list of UL signals to request/activate the respective AS configuration includes signaling for an index of a random access channel (RACH) preamble and an associated AS configuration. In yet another example aspect, the mapping of the list of UL signals to request/activate the respective AS configuration includes signaling of an indication and an associated AS configuration. In certain examples, subsequent to the sending, to the AIoT device, the received data with the QoS level or after receiving a response to the data from the AIoT device, the WTRU reports, to the base station, completion of the AIoT operation. Additional aspects features and/or advantages will be apparent from the description of the embodiments which follow.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example timing diagram of a sequence of messages in a procedure between an interrogator and an RF tag;

FIG. 3 is an example network diagram of a first topology with an Ambient Internet of Things (AIoT) device communicating directly with a base station;

FIG. 4 is an example network diagram of a second topology with an AIoT device communicating with an intermediate node that communications with a base station;

FIG. 5 is an example network diagram of a third topology with an AIoT device transmitting data/signaling to a base station and receiving data/signaling from an assisting node (i.e., downlink assistance);

FIG. 6 is an example network diagram of the third topology with an AIoT device receiving data/signaling from a base station and transmitting data/signaling through an assisting node (i.e., uplink assistance);

FIG. 7 is an example network diagram of a fourth topology where an AIoT device communicates bidirectionally with a WTRU;

FIG. 8 is a block diagram illustrating a 5GS enhancement to support AIoT devices for the second topology shown in FIG. 4;

FIG. 9 is a block diagram illustrating a protocol stack to support AIoT services for the second topology shown in FIG. 4;

FIG. 10 is a block diagram illustrating a protocol stack for application function (AF)-based solution (over the user plane) for the second topology shown in FIG. 4;

FIG. 11 is a block diagram illustrating an example protocol stack to support AIoT for the second topology shown in FIG. 4;

FIG. 12 is network diagram illustrating an example of Uu bearer and AIoT configuration for QoS for the second topology shown in FIG. 4;

FIG. 13 is a network message diagram for a method of determining an AIoT configuration based on QoS levels according to a first example embodiment;

FIG. 14 is a network message diagram for a method of uplink transmission with AIoT configuration based on QoS levels according to a second example embodiment;

FIG. 15 is a flow diagram illustrating a method for use by a wireless transmit receive unit (WTRU) determining an AIoT configuration based on QoS levels according to an example embodiment; and

FIG. 16 is a flow diagram illustrating a method for use by a WTRU in uplink transmission with AIoT configuration based on QoS levels according to another example embodiment.

### DETAILED DESCRIPTION

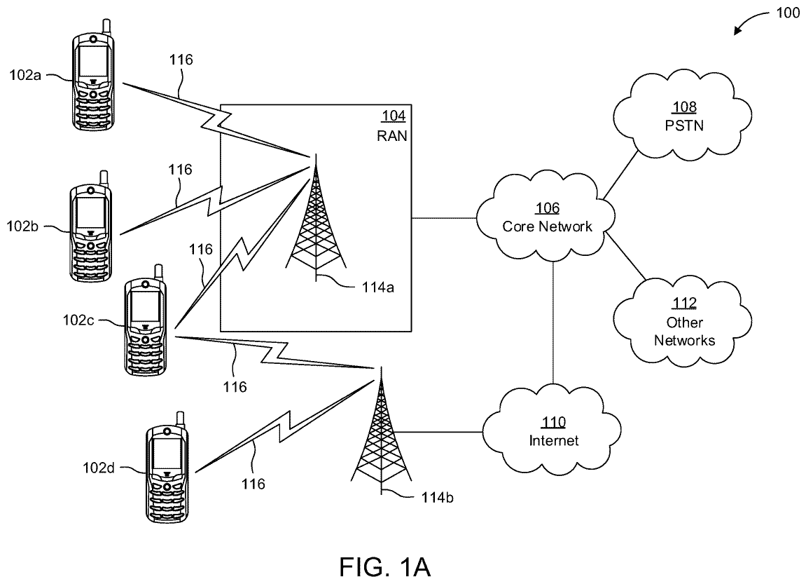

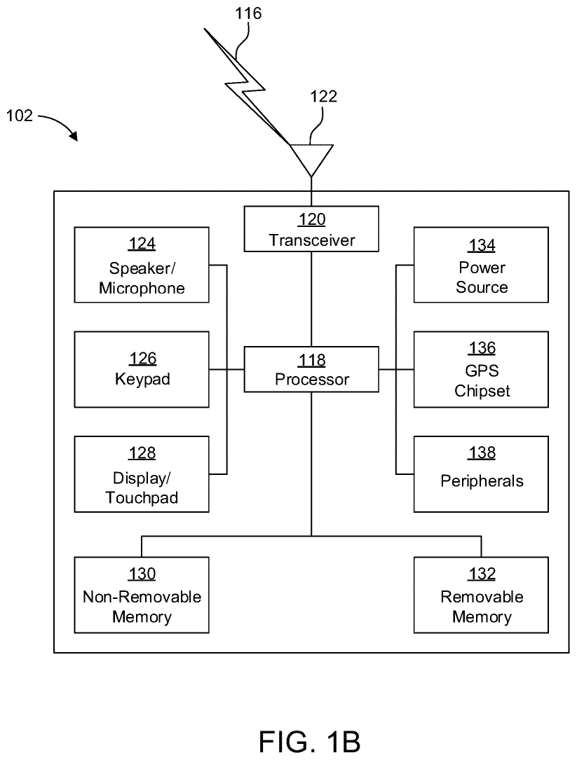

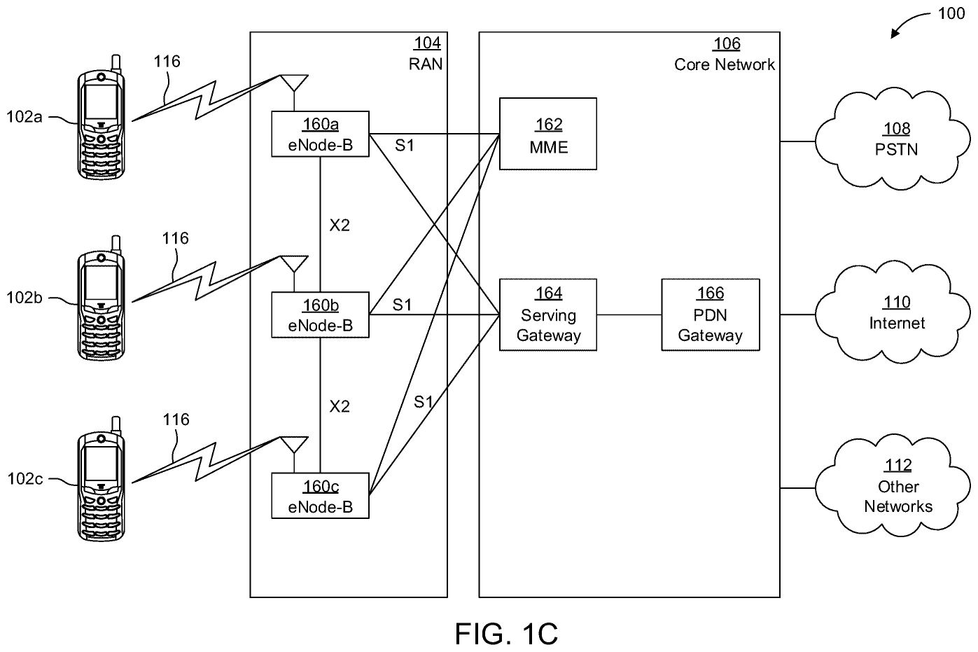

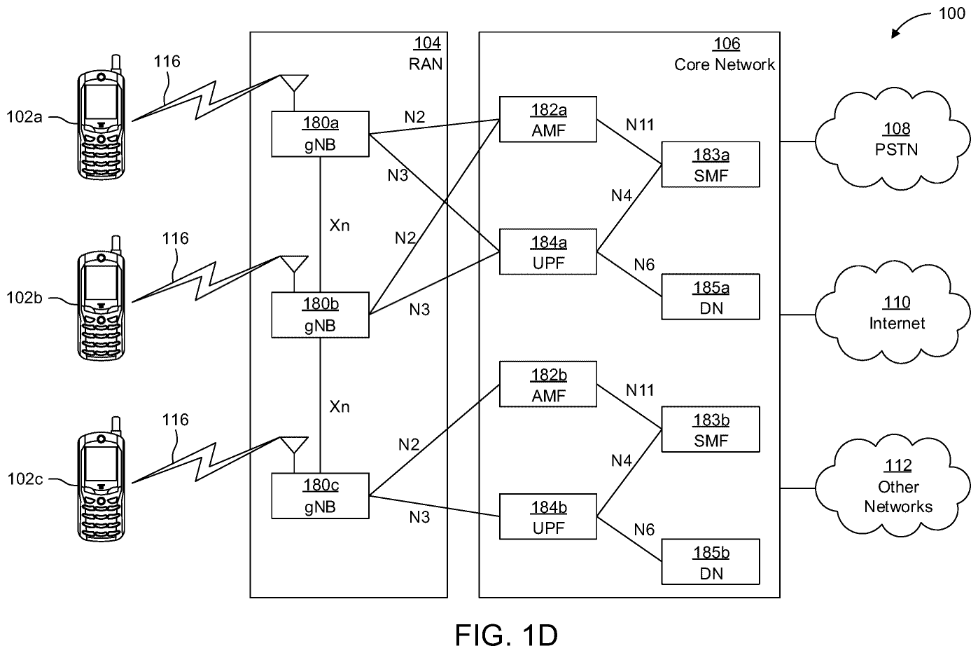

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As mentioned previously, in recent years, IoT has attracted much attention in the wireless communication world. More ‘things’ are expected to be interconnected for improving productivity efficiency and increasing comforts of life. Further reduction of size, complexity, and power consumption of IoT devices can enable the deployment of tens or even hundreds of billions of IoT devices for various applications and provide added value across the entire value chain. It is impossible to power all the IoT devices by battery that needs to be replaced or recharged manually, which leads to high maintenance cost, serious environmental issues, and even safety hazards for some use cases (e.g., wireless sensor in electric power and petroleum industry).

Most of the existing wireless communication devices are powered by battery that needs to be replaced or recharged manually. The automation and digitalization of various industries open numbers of new markets requiring new IoT technologies of supporting battery-less devices with no energy storage capability or devices with energy storage for which batteries do not need to be replaced or recharged manually. The form factor of such devices must be reasonably small to convey the validity of target use cases.

An example type of application is asset identification, which presently has to resort mainly to barcodes and RFID in most industries. The main advantage of these two technologies is the ultra-low complexity and small form factor of the tags. However, the limited reading range of a few meters usually requires handheld scanning which leads to labor intensive and time-consuming operations, or RFID portals/gates which leads to costly deployments. Moreover, the lack of interference management scheme results in severe interference between RFID readers and capacity problems, especially in case of dense deployment. It is challenging to support large-scale networks with seamless coverage for RFID.

A radio access network (RAN) 2 effort has recently provided a study to decide which functions are needed for an Ambient IoT compact protocol stack and lightweight signalling procedure to enable DO-DTT and DT data transmission, and study those functions. Examples of functions include paging, random access (RA), data transmission, including necessary radio resource control (RRC) aspects and interactions with upper layers. For functionalities not listed, they are studied only if found essential.

One RFID specification describes example steps in which an interrogator inventories and accesses a single tag. Some implementations provide functions for an AIoT compact protocol stack and lightweight signaling procedure to enable Device Originated Device Terminated Triggered (DO-DTT) and Device Terminated (DT) data transmission. In some implementations, this may include paging, random access, data transmission (e.g., including necessary radio resource control aspects), and/or interactions with upper layers.

In the example embodiments disclosed herein, inventory may refer an overall procedure of a interrogator (or reader) triggering access by one or more tags (devices) using a sequence of messages (e.g., query message and query rep message(s) in an RFID procedure). The tag(s) (devices) may respond to access and perform an RFID procedure when receiving the message from the interrogator (or reader/UE/WTRU).

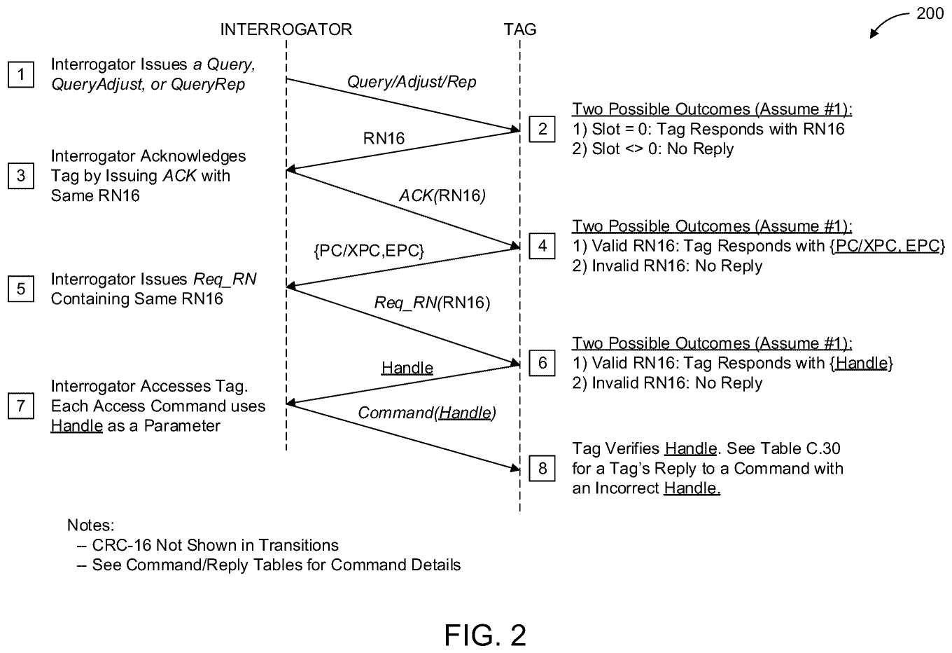

Referring to FIG. 2 a message sequence chart illustrates an example communication method 200 for an RFID interrogator to inventory and access an RFID tag. In step 1, the interrogator sends a message (e.g., query) to query one or more tags. In one example, a query round refers to the overall inventory procedure of an interrogator triggering access with multiple tags using a sequence of messages In method 200, the interrogator sends a Query, QueryAdjust, or QueryRep message to the tag(s) in step 1. In one example, when receiving a queryrep message a tag may decrement its counter (random number) RN until the counter reaches 0. In one example, a queryadjust message is used for the tag to generate a new random number. In one example, the query message indicates to energize all or a subset of the one or more tags which may generate a new random number for initial access.

According to the RFID inventory procedure, a query message initiates one round of the inventory procedure, and the query message including a parameter Q, which is used by the interrogator to regulate the probability of a device/tag response. Upon receiving a query message (or queryadjust) message, a tag may select its slot counter to a value between 0 and 2\hat{ }Q-1 derived from the parameter Q. Then the device may decrement their slot counter every time upon receiving a queryrep. When the tag's slot counter reaches zero, at step 2, the device may transmit a 16 bit random number (RN16). On condition that the slot counter equals 0, the tag sends an RN16 message to the interrogator. If the slot counter does not equal 0, the tag does not send the RN16 message (i.e., does not reply to the interrogator). In response to the RN16 message, at step 3, the interrogator acknowledges receiving the R16 message by sending an acknowledgement (ACK), including the same R16 received from the tag. On condition that the ACK at step 3 includes a valid RN16 (e.g., the same RN16 generated/transmitted by the tag at step 2), at step 4, the tag sends a protocol control (PC)/extended protocol control (XPC), electronic product code (EPC) message. In one example, upon receiving the valid RN16, a tag may transmit the tag's unique identity information (e.g., PC/XPC, EPC). Otherwise, on condition that the ACK does not include a valid R16 (e.g., not the same RN16 generated/transmitted by tag in step 2), the tag does not send the PC/XPC, EPC message (i.e., does not reply to interrogator at step 4). In response to receiving the PC/XPC, EPC message, at step 5, the interrogator sends Req_RN message to the tag (e.g., to check the successful reception of the PC/XPC EPC message from step 4), including the same R16 as in the R16 message from step 2 and ACK from step 3. On condition 220 that the Req_RN message includes a valid R16, at step 6, the tag sends a handle to interrogator. Otherwise, on condition that the Req_RN message from step 5 does not include a valid R16, the tag does not send a handle to the interrogator (i.e., does not reply to the interrogator). After receiving the handle, at step 7, the interrogator has access to the tag, and can issue commands using the handle as a parameter. As shown in step 7, the interrogator sends a command message to the tag, which includes the handle as a parameter. In step 8, the tag verifies the handle before accepting the command.

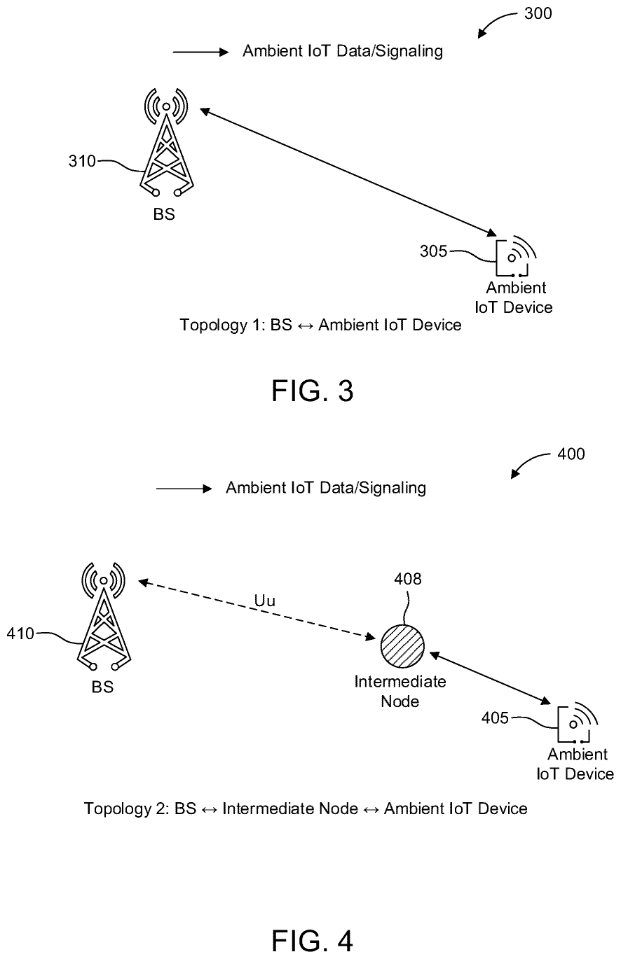

In recent 3GPP efforts, topologies were defined for various AIoT deployment and data/signaling scenarios. Referring to FIG. 3, an example network topology 300, e.g., referred to as Topology 1, is shown for an Ambient IoT device 305 to directly communicate with a base station (BS) 310, e.g., bidirectionally. The communication between the base station 310 and the ambient IoT device 305 includes Ambient IoT data and/or signalling. Topology 300 includes the possibility that the BS transmitting to the Ambient IoT device 305 is a different from the BS receiving from the Ambient IoT device 305.

Referring to FIG. 4, another example network topology 400, e.g., referenced as Topology 2, is shown in which an Ambient IoT device 405 communicates with a base station 410 via an intermediate node 408 between AIoT device 405 and base station 410. In topology 400, the intermediate node 408 can be a relay node, an integrated access and backhaul (IAB) node, a UE/WTRU, a repeater, etc., which is capable of Ambient IoT communication. The intermediate node 408 transfers the information to and from BS 410 and AIoT device 405.

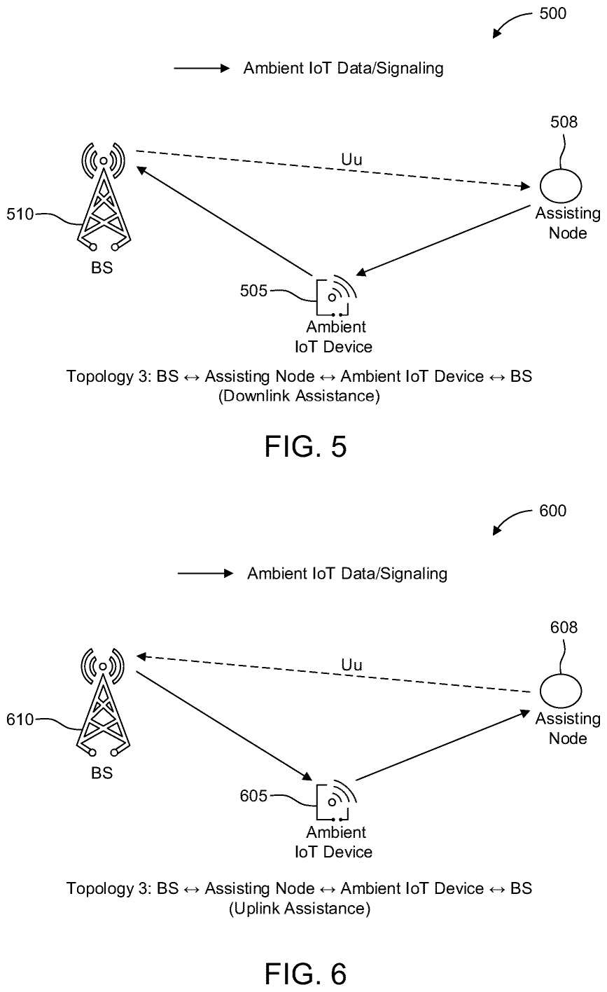

In FIG. 5 and FIG. 6, other example network topologies 500 and 600, collectively referenced as Topology 3, are shown. FIG. 5 network topology 500 and FIG. 6 topology 600 are similar by including respective assisting nodes 508 and 608, to facilitate assistance for transmissions in either downlink or uplink communication for the AIoT device.

For example, in FIG. 5 network topology 500, AIoT device 505 transmits data/signalling directly to base station 510, but receives data/signalling from BS 510 through assisting node 508. In FIG. 6 network topology 600, AIoT device 605 receives data/signalling directly from a base station 610 but transmits data/signalling to BS 610 through the assisting node 608. In Topology 3, the assisting node can be a relay node, an IAB, UE/WTRU, repeater, etc. which is capable of ambient IoT communication.

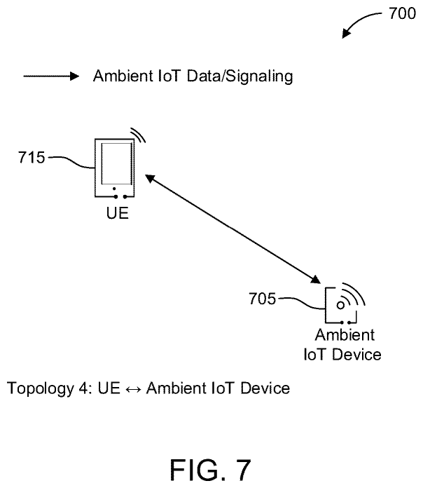

Referring to FIG. 7, yet a further network topology 700, referred to as Topology 4, is shown in which an AIoT device 705 communicates bidirectionally with a WTRU 715. The communication between WTRU 715 and the AIoT device 705 includes AIoT data and/or signalling.

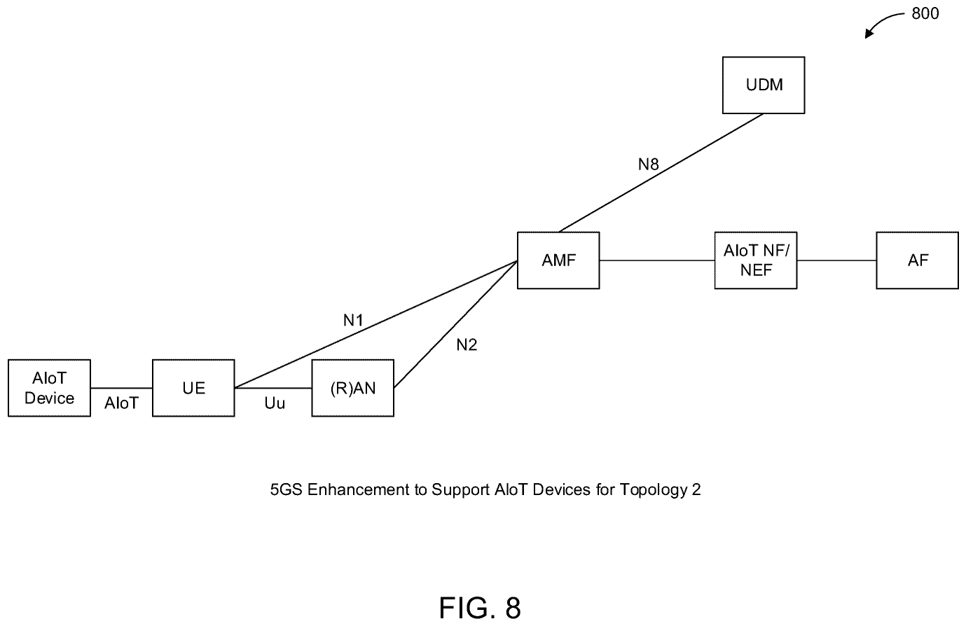

AIoT information transfer between a CN and a WTRU will not be described, including transfer via non-access stratum (NAS)-layer and access stratum (AS)-layer and associated protocol stacks for AIoT topologies (e.g., NAS-based/packet data unit (PDU)-based/RRC-based) NAS-based information transfer for AIoT is described. Referring to FIG. 8, NAS-based information transfer AIoT framework 800 is shown for the fifth generation system (5GS) enhancement to support AIoT devices. Considering the nature of the AIoT Devices (e.g. ultra-low complexity power, cost and resource-constrained), the legacy PDU Session/QoS Flow based data transfer is not suitable for such AIoT devices. This solution applies to those AIoT devices that are not capable of direct communication with a 5G network, and instead, may communicate with the network through an Intermediate Node (IN), or “IN-WTRU” (e.g., WTRU, UE, reader). The AIoT device and the IN-WTRU may communicate with each other using backscattering communication or other sidelink technologies. It is assumed that the AIoT device is able to identify itself, e.g. using its Device Identifier, over the “AIoT device-WTRU”interface.

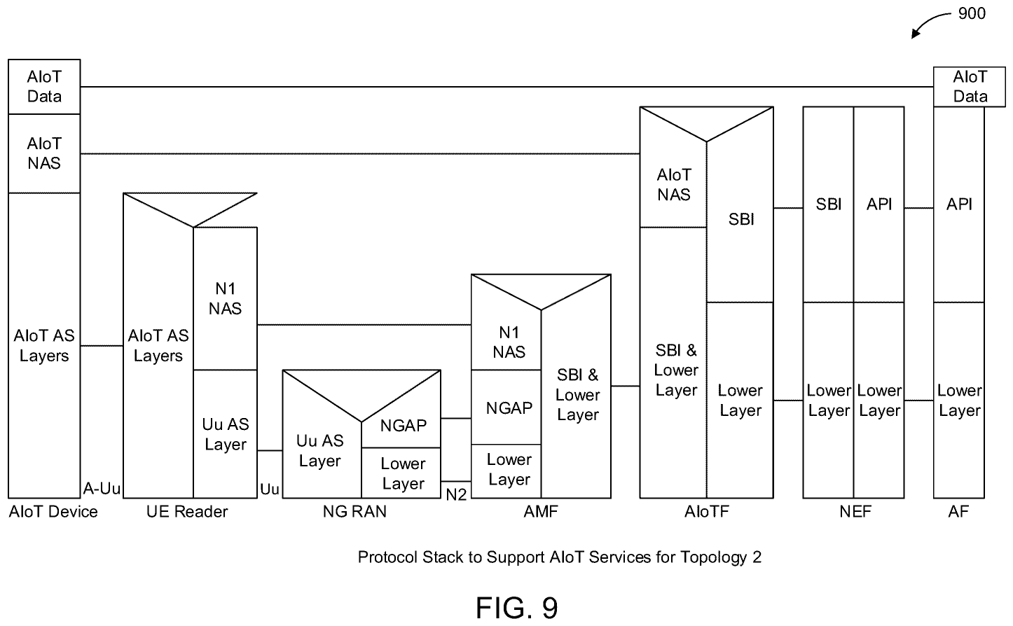

Referring to FIG. 9, a protocol stack 900 is shown to support AIoT service for topology 2, referenced previously in FIG. 4. The system architecture and functions as defined in TS 23.501 are used as a basis to support the Ambient IoT services/operations (e.g. inventory and/or command procedures) with the following clarifications.

For example, the AIoTF (AIoT function/network function in FIGS. 8-9 is introduced to support transfer of service requests from an application function (AF) (via the network exposure function (NEF)) to the WTRU/UE Reader, and transfer of service responses from the WTRU to the AF (via the NEF). The NEF may be enhanced to support transfer of service requests from the AF to the AIoTF, and transfer of service responses from the AIoTF to the AF. Additionally, unified data management (UDM) in FIG. 8 framework 800 may be enhanced to support authorized AIoT service requests from the AF, and AIoT service responses from the UE/WTRU. Furthermore, the access and mobility management function (AMF) may be enhanced to support authorization of WTRU communications with AIoT devices, and to support transfer of service requests from the AIoTF to the WTRU and transfer of service responses from the WTRU to the AIoTF. Likewise, a WTRU may be enhanced to support communication with AIoT Device and interaction with AIoTF.

In one example, as shown in the FIG. 9 protocol stack 900, it is assumed the AIoT device communicates with the WTRU via a new AIoT interface where both the Access Stratum (AS) layer and the Non-Access Stratum (NAS) layer are supported. The WTRU communicates with the network using the existing Uu interface. For topology 2, the WTRU performs the reader functions to send the AIoT service requests (e.g. inventory, command) to the AIoT devices and receives AIoT service responses (e.g. Device ID, AIoT data) from the AIoT devices. The WTRU may also act as an intermediate node which is under the network control. This solution proposes a control plane (CP)-based approach for the core network (CN) to select the WTRU and to transfer the AIoT service request/response between the WTRU and the AF.

In one example, the AF requests one or more service operations for an AIoT device or a group of AIoT devices or all of the AIoT devices via the NEF, and the NEF forwards the requested service operation(s) to the AIoTF. The AIoTF selects the WTRU and delivers a requested service operation to the WTRU. The WTRU performs the service operation (e.g. inventory, command) with the AIoT devices and transfers AIoT information (e.g. Device ID, AIoT data) received from the AIoT devices to the AIoTF. The AIoTF then sends the AIoT information to the AF via the NEF.

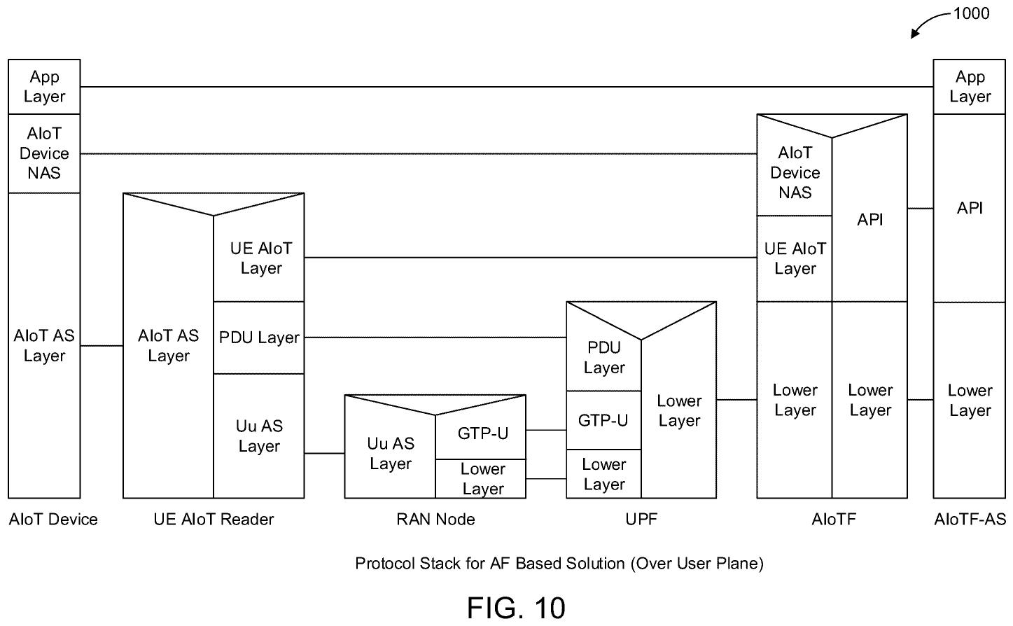

PDU-based information transfer for AIoT is described. This solution also focuses on the Topology 2 and FIG. 10 shows an example architecture and protocol stack 1000 for an AF-based AIoT solution over the user plane (UP). A WTRU, which is capable of AIoT transmissions towards AIoT devices, is called a “WTRU/UE AIoT Reader”. The WTRU AIoT Reader may indicate it's AIoT capability during the registration with the network. This solution proposes that the AIoT data/information transfer between the AIoT application server (AIoT AF) and the AIoT devices is executed via the UP of a PDU session. A new NF called Ambient AIoT function (AIoTF) is introduced which is located with the control plane (CP) and can be accessed via IP connectivity (e.g. via the UP and the N6 LAN).

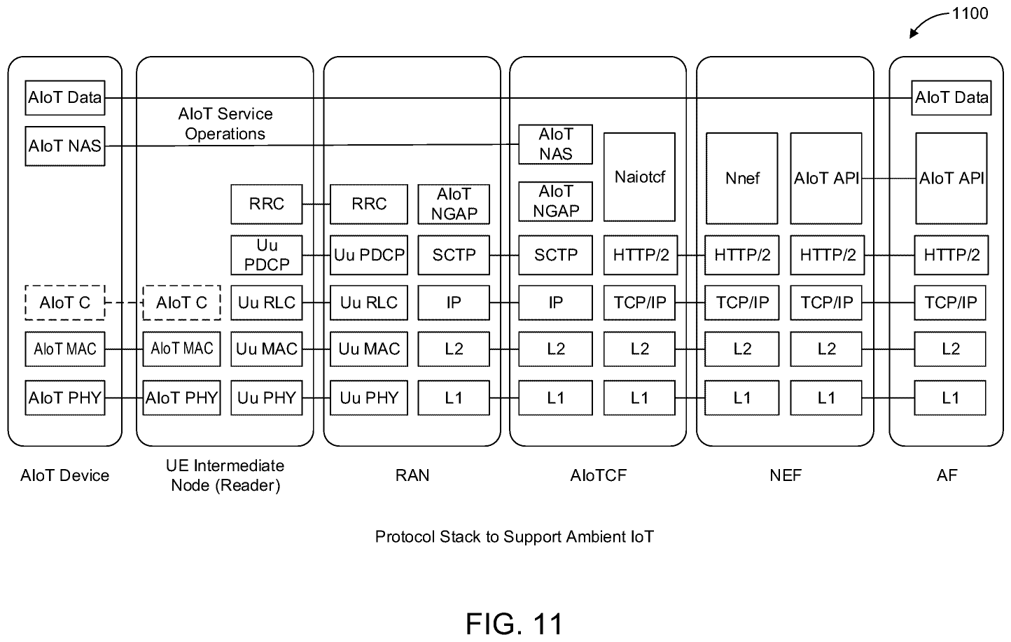

RRC-based information transfer for AIoT is described. Referring to FIG. 11, an example protocol stack 1100 is shown to support AIoT devices for Topology 2. In this solution, the 5G core (5GC) has a new network function AIoTCF (Ambient IoT Controller Function) to support different AIoT service operations (command, inventory, etc.). The AIoTCF registers the readers and authorizes the AFs for different AIoT service operations. The AIoTCF discovers and selects readers for different service operations initiated by the AF. The AIoTCF can be integrated with the AMF as well.

The reader supports the AIoT-Uu air interface with the AIoT device. In this regard, the AIoT C layer (control, e.g., RRC layer) is the optional control protocol between the AIoT device and the reader and will be defined by the radio access network (RAN). The AIoT next generation application protocol (AIoT NGAP) is the interface between the reader and the AIoTCF and can be a lightweight version of an NGAP protocol tailored for AIoT, or a new different protocol. The AIoTCF exposes the Naiotcf interface and in case the AIoTCF is integrated with AMF, the Namf interface can be enhanced.

In future AIoT services with Topology 2, the WTRU (e.g., reader, intermediate-node) may need to differentiate and/or prioritize AIoT operations with different QoS requirements (e.g., completion time). For example, the WTRU may need to provide different QoS levels for the same inventory procedure. Two distinct inventory procedures may be targeted with different completion times based on the requested number of devices or requested services, (re-)transmission for the specific device.

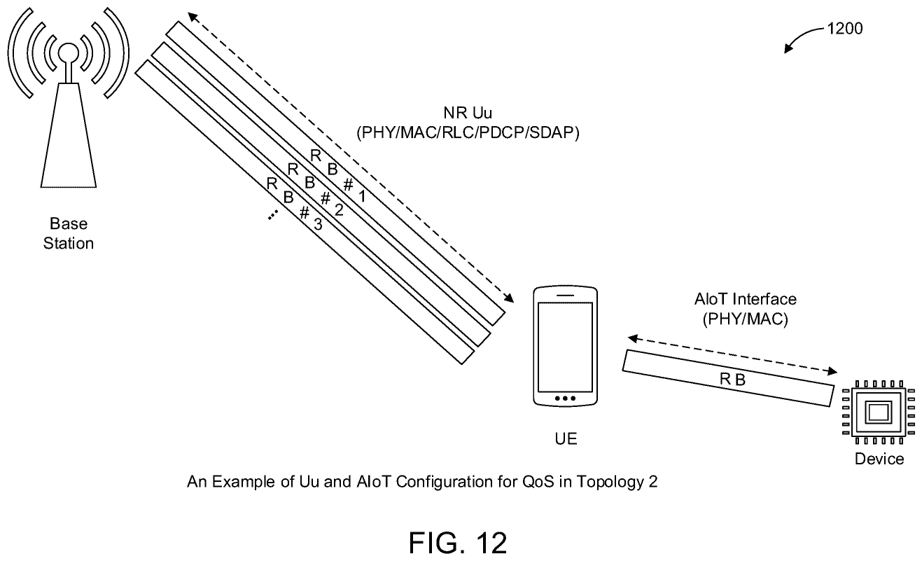

Since AIoT transmission between the WTRU and the AIoT device utilize Uu resources shared with other new radio (NR) WTRUs, the gNB should maintain control of the amounts of resources for AIoT devices by considering QoS requirements of AIoT services along with other Uu services for other NR WTRUs. However, in the NAS-based model described previously, the QoS level of AIoT data is decided by the core network, and details for an inventory/command procedure (e.g., latency requirements) may therefore not be known by the gNB. This prevents the gNB from allocating appropriate Uu resources for AIoT operations according to the QoS level. Moreover, if the gNB configures possible amounts of resources based on QoS requirement of the AIoT service in advance, the additional Uu resources may be wasted since the gNB does not know when the AIoT data with the QoS may not be triggered and/or how often it would be triggered. This unbalanced potential of resource assignment may be seen in FIG. 12, example network diagram 1200 where Uu Radio Bearers (RBs) #1, #2 and #3 are overly allocated/unused compared to the AIoT interface between the WTRU/UE/reader and device, which is using only one RB.

Embodiments described herein may address for the foregoing issues, including: (i) upon arrival of AIoT data from the CN, how does the WTRU know the QoS of the AIoT data and corresponding the AS configuration (e.g., resources/TX parameters) for R2D/D2R transmissions for AIoT interface; (ii) what information needs to be configured with the WTRU for supporting QoS for AIoT; and/or (iii) how to map/determine an AS configuration with QoS levels of arrived AIoT data.

Common terminology to the embodiments in this disclosure are described. The terms WTRU/UE, intermediate node and/or I-node in Topology 2 may refer to the reader which is an entity that queries the AIoT device. As a result, the term reader may refer to a WTRU/UE or network node depending on the context and/or the topology.

The terms device, Ambient IoT device, AIoT device and tag are used interchangeably to mean the AIoT device that is being inventoried/queried by the reader/WTRU/UE. The term WTRU or UE refers to the entity which queries the AIoT device, either directly (e.g., reader), or via an intermediate WTRU in Topology 2. The term of paging refers to the AIoT paging which queries the AIoT device from the CN.

As previously described, in Topology 2, the AIoT device communicates bidirectionally with an intermediate node between the device and base station. In this topology, the intermediate node can be a relay (e.g., layer-2/layer-3), integrated access/backhaul (IAB) node, WTRU/UE, repeater, etc., which is capable of AIoT. The intermediate node transfers AIoT data and/or signalling between base station and the AIoT devices. The term RACH or RACH procedure or RA are used interchangeably to mean an initial access procedure or random access or RACH procedure in inventory procedure.

In this disclosure, a query round refers to the overall inventory procedure of a WTRU triggering access by multiple devices using a sequence of messages. Specifically, the inventory procedure refers to a single round of attempts to have each device respond or attempt to respond with its device ID or access ID. Specifically, the inventory procedure refers to a set of access occasions which may have 0 or at least 1 device respond within the access or paging occasion. As used herein, an inventory procedure may be similar to legacy RFID procedure. Although referred to herein as inventory procedure, it may be termed differently in device requirements or specifications (e.g., query procedure, paging procedure, RACH procedure, etc.).

In this disclosure, a QoS profile for AIoT operation refers a required/requested QoS level for an AIoT operation via the Uu interface, similar to 5QI (5G QoS Identifier) via the Uu interface. The QoS profile is a pointer related to AIoT QoS characteristics, e.g., overall completion time of an inventory and/or command procedure or response time/successful time for triggered message/event/procedure or packet delay budget (PDB) or packet error rate (PER) while performing a specific AIoT operation between the device and reader and/or device and NW (e.g., base station and/or core network).

Initial access for an inventory procedure will now be described. It should be noted that, while comparison is made to the RFID example previously described, the embodiments are in no way limited to RFID specifics and terms and are provided merely as an example. As used herein, an initial access (e.g., RACH) procedure may be initiated with a device's first transmission during an access occasion (e.g., using the slot counter in random access RFID described previously). Such a transmission may be similar to the transmission by the device in the RFID inventory procedure to indicate the device ID, and may be followed by a confirmation of the device ID by the reader or other indicator. Such transmission may be initiated by the device upon reception of an indication that an access occasion has been started by the reader. As with the previously described RFID example, the indication of a start of an access occasion may be signaled in a message from the reader (e.g., in the query, queryadjust and/or queryrep message).

A device may initiate a RACH procedure only in a specific access occasion. The access occasions may be delimited by certain transmissions by the reader (e.g., similar to RFID where each queryrep denotes the start of an occasion). Alternatively, a device may initiate a RACH procedure in multiple occasions. Alternatively, a device may initiate a RACH in an occasion indicated by the reader in the query message.

In various embodiments, a device may perform contention-based or contention-free RACH procedure. In contention-free RACH procedure, the device may send a different set of information compared to contention-based RACH procedure. In contention-based RACH procedure, the device may include its device ID while transmitting based on its access occasion. In one example, the device ID may be a number (e.g., 16-bit random number, 16-bit pseudo-random number). In a contention-free RACH procedure, the device may include no device ID. Specifically, in the case the initial message which starts the occasion (e.g., the query rep or similar message) includes a device ID for that occasion, the device may initiate a contention-free RACH procedure any may transmit any of the other configuration related information, or buffer status without including a device ID.

In various embodiments, a command procedure is triggered by a WTRU (e.g., reader) for one or more AIoT devices after an inventory procedure is completed (e.g., RACH procedure and/paging/query procedure). For example, a WTRU may trigger a command procedure for one or more devices after completing the inventory procedure. For example, the WTRU may perform data communication with the device(s) via the AIoT interface during a command procedure. In an example, the WTRU may send a command with an operation request (e.g., read, write, erase) with one or more devices. For example, a read command is used by the WTRU to retrieve (e.g., all/a part of/portion of) device information (e.g., in memory, EPC memory, tag identifier (TID) memory, etc.). For example, a write command from the reader allows to write a word and/or information in a device's memory (e.g., memory, EPC memory, TID memory). An erase command may reset (e.g., partially or fully) data in the device's memory. There may be other commands, e.g., a sensing command, not expressly described here but which are consistent with the term command or command procedure of the described embodiments.

Quality of Service (QoS) for AIoT is now described. In various embodiments, AIoT QoS may be associated with an inventory procedure and/or a command procedure for AIoT operation. In one example, an AIoT operation with QoS may be considered maximum/minimum latency requirement (e.g., similar to 5G QoS identifier) and completion time in an inventory procedure (e.g., with number of (re-)transmissions and/or with configured to use delay critical resource type). For example, an AIoT operation QoS may be associated with minimum/maximum packet loss for the inventory and/or command procedure.

In one example, using an AIoT QoS profile, the network (e.g., CN, base station) may/can prioritize a step of the inventory or command procedure and/or the entire inventory/command procedure and/or transmission of one or more of the messages for inventory and/or command procedure. In the same way, using QoS profiles, a device and/or WTRU may prioritize one of the step/flows within the inventory procedure and/or among the inventory procedure and/or transmission/reception of the message for inventory and/or command procedure.

In one example, a latency for inventory may be defined that the maximum/minimum time that the inventory request is sent from the BS/reader/WTRU to an AIoT device and the time that the inventory report is successfully received at the BS/reader/WTRU from the AIoT device. For example, a latency for inventory may be defined that the maximum/minimum time that an initial paging is sent from BS/reader/WTRU to one or more AIoT devices and the minimum/maximum time that the paging response (or RACH procedure) is successfully received (or completed) at BS/reader/WTRU from the one or more AIoT devices.

Each of the inventory request may be configured with different QoS requirements. For example, a latency requirement for paging retransmission after initial transmission for the device may be shorter than the requirement latency for initial paging for the device. For example, the requirement latency for paging request for the multiple devices may be longer than the requirement latency for initial paging for the single device or a group of devices.

In one example, for an inventory procedure, the latency requirement for MSG2 transmission from the reader may be different for initial transmission and retransmission. For example, the latency requirement for paging (re-)transmission from the reader may be different depends on the paging request of inventory procedure. For example, the number of paging (re-)transmission may be different based on the paging request. For example, the latency requirement for MSG1 and MSG3 (re-)transmission from the device may be different for initial transmission and retransmission. For example, the device may be a delay sensitive device.

In one example, the latency for command procedure may be defined that the time that the DL command is sent from BS/reader/WTRU and the time that the command is successfully received at AIoT device. For example, the latency requirement for read command may be different depending on the request. For example, the read command request to read all information of the device memory. For example, the read command request to read part of the information of the device memory.

Solutions are disclosed for determining an AIoT configuration based on QoS.

In various embodiments, a WTRU receives an AIoT configuration with QoS level. In an example, a WTRU may receive a service request from the network (e.g., core network (CN) and/or AMF and/or AIoT function server) for triggering an inventory procedure and/or command procedure. Each of the triggered service requests may be associated with an inventory procedure and/or a command procedure. For example, an inventory procedure may be initiated by receiving a message, e.g., paging message, round initiation message, query message.

In various embodiments, each service request may be associated with at least one QoS profile (e.g., QoS level and/or a latency requirement). As an example, an initial paging message is configured with one QoS profile (e.g., QoS profile #1) and/or a query message may be configured with one QoS profile (e.g., QoS profile #2). In one example, one service request (e.g., an inventory procedure) with one or more messages may be configured with one or more QoS profiles when an initial inventory procedure is triggered and/or initiated.

In another example, each service request (e.g., command procedure) may be associated with at least one QoS profile (and/or QoS level and/or latency requirement). For example, a read command is configured with a QoS profile (e.g., QoS profile #1) and/or a write command may be configured with a QoS profile (e.g., QoS profile #2). For example, one service request (e.g., command procedure) with one or more messages may be configured/associated with one or more QoS profiles.

According to example embodiments, each service request may be associated with and/or targeted to one or more devices (e.g., for a single device, a group of devices, or all devices). In one example, upon receiving a triggering message (e.g., AIoT paging or query), the WTRU may initiate an inventory round and/or command procedure. For example, the triggering message of an inventory procedure may be commonly used in Topology 1 and Topology 2.

In various embodiments, an inventory procedure may be initiated/transmitted/triggered by a network and/or a core network (e.g., AMF/AIoT function server) via signaling in the NAS layer between the WTRU and core network.

Embodiments may include reporting one or more QoS profiles to a base station, e.g., a gNB. In one example, a WTRU may report one or more received QoS profiles (e.g., received from the CN) to the base station. In one example, when a WTRU receives a service request with one or more QoS profiles from the CN, the WTRU may report the received QoS profile(s) associated with an inventory procedure and/or command procedure, to the base station.

According to various examples, a WTRU may report the received one or more QoS profiles via a medium access control (MAC) control element (CE) and/or RRC message (e.g., as assistance information for the AIoT interface, AS configuration request for the AIoT interface) upon receiving the QoS profile(s) (i.e., reporting immediately). When the WTRU reports the received one or more QoS profiles, the base station may configure one or more AS configurations for an AIoT operation with related QoS profiles according to reported QoS profiles. The base station may be ready to activate the AIoT operation with configuration of the AS configurations.

Receiving configuration of bearers and/or priority may be utilized in certain embodiments. For example, a WTRU may receive or configured with a list of AS configurations for one or more AIoT operations, e.g., for use in the AIoT interface. In embodiments, each of the AS configurations may be associated with at least one of the QoS levels (e.g., QoS profile) for a specific AIoT operation. In one example, each AS configuration may be associated with an inventory procedure and/or a command procedure. In one example, each AS configuration may be associated/configured with one or more inventory rounds (e.g., association with a specific round and/or specific rounds).

In certain embodiments, a WTRU may receive a mapping configuration of Uu bearer and/or dedicated Uu bearer and associated with an AS configuration, from base station. When at least an AIoT data for inventory and/command procedure arrived or is delivered via the configured Uu bearer and/or dedicated Uu bearer (possibly with a priority), then the WTRU may use associated AS configuration based on the Uu bearer and/or priority with arrived/delivered AIoT data for the AIoT operation.

According to some embodiments, a Uu bearer is associated/configured with at least one Uu data radio bearer and/or signaling radio bearer and/or Uu logical channel. The base station, in one example, may configure the mapping configuration to a WTRU via a system information broadcast (SIB) and/or a RRC message and/or a MAC CE. In one example, for mapping Uu bearer/dedicated bearer and AS configuration for AIoT operation, configurations may be considered as described below (e.g., for both WTRU and device perspectives):

Examples for mapping with configured Uu bearers and AS configurations are described as follows:
In one example, a WTRU may be configured with a list of configured Uu bearer and associated AS configuration for AIoT operation. The one or more Uu bearers for Uu transmission may be mapped to one or more AS configurations for AIoT operation.
In one example, a WTRU may be configured with a DL Uu bearer and an associated AS configuration (e.g., R2D transmission parameters) and resources (e.g., WTRU to device).
In one example, a WTRU may be configured with a UL Uu bearer and associated AS configuration (e.g., D2R transmission parameters) and resource (e.g., device to WTRU).
In one example, each of the Uu bearers (DL/UL) with high priority (e.g., low latency, high reliability) may be mapped to an associated AS configuration with D2R/R2D transmission parameters and resources based on the QoS levels. For example, the QoS level is associated with a required completion time for inventory and/or command procedure.
In one example, each of the Uu bearers (DL/UL) with low priority (e.g., latency tolerant, low reliability) may be mapped to an associated AS configuration with D2R/R2D transmission parameters and resources based on the QoS levels. For example, the QoS level is associated with a required completion time for inventory and/or command procedure.

Examples for mapping with dedicated Uu bearer(s) with priorities and AS configurations are described as follows:
In one example, a WTRU may be configured with a dedicated Uu bearer and associated AS configuration for an AIoT operation. The dedicated Uu bearer may be configured among the configured Uu bearers and/or be a newly configured Uu bearer used for an AIoT operation (e.g., mapping of AS configuration).
In one example, a WTRU may be configured with one or more priorities and associated with one or more AS configurations for AIoT operation. Each priority may be associated with at least one QoS level and/or QoS profile. For example, a priority may indicate a latency requirement (e.g., completion time) of AIoT data and associated AIoT procedure. For example, when an AIoT data with a priority arrives/is delivered via the dedicated bearer, the WTRU may determine an AS configuration based on the indicated priority of the arrived AIoT data.
In one example, a priority with AIoT data is transmitted/indicated via MAC CE and/or downlink control information (DCI) and/or RRC message from the base station to the WTRU. For example, the priority value(s) (e.g., 1 to N) of the AIoT data can be piggybacked to one of the current AIoT messages (e.g., paging, query, write). For example, the priority value(s) (e.g., 1 to N) of the AIoT data can be transmitted via new AIoT messages (e.g., am AIoT message for indication of one or more priorities).
In one example, each of the AIoT data with a high priority (e.g., low latency, high reliability) may be mapped to an associated AS configuration with D2R/R2D transmission parameters and resources based on the associated QoS level. For example, the QoS level is associated with a required completion time for inventory and/or command procedure.
In one example, each of the AIoT with a low priority (e.g., latency tolerant, low reliability) may be mapped to an associated AS configuration with D2R/R2D transmission parameters and resources based on the associated QoS level. For example, the QoS level is associated with a required completion time for an inventory and/or a command procedure.
According to one solution, a WTRU may determine/select at least one of the AS configurations when an AIoT data has arrived and/or is delivered using at least one of the configured Uu bearers according to the mapping of Uu bearers and AS configurations.
In another solution, a WTRU may determine at least one of the AS configurations based on a priority when an AIoT data with an indicated priority has arrived and/or is delivered on the configured dedicated Uu bearer according to the priority of dedicated bearer and AS configurations.
In other solutions, upon receiving a mapping configuration (e.g., Uu bearers/dedicated Uu bearer and AS configuration), a WTRU may activate the received mapping configuration upon receiving an activation indication/signal/message (e.g., DCI, MAC CE, RRC message).
According to various embodiments, upon receiving a new QoS profile(s) (e.g., newly received from the CN), a WTRU may determine to report the new QoS profile(s) to the base station. The base station may then configure a new mapping configuration to the WTRU.
In other embodiments, upon receiving a new QoS profile(s) (e.g., newly received from the CN), a WTRU may determine to request to (re-)configure (e.g., request a new mapping with the newly received QoS and/or release the current mapping configuration) a new mapping configuration (e.g., Uu bearer/dedicated Uu bearer and AS configuration with the newly received QoS profile(s)).

Embodiments with AS configuration for AIoT operation are now described. In one example, an AS configuration for AIoT operation (e.g., resources and/or transmission parameters of the device and/or WTRU) is determined by a WTRU (e.g., reader/I-node) based on QoS level(s) which are associated/involved with an inventory and/or command procedure. The resources may include a Uu resource (e.g., for sharing Uu resources/frequency resource with normal/legacy NR WTRU). In one example, transmission parameters for the device from a reader (e.g., R2D transmissions) and transmission parameters for the reader from a device (e.g., D2R transmissions) can be considered. The transmission parameters may be used or can be used in transmission in physical layer) and/or MAC layer.

In some embodiments, a WTRU may determine D2R transmission parameters for the one or more devices based on the determined/selected AS configuration. In one example, a WTRU may deliver the determined D2R transmission parameters to one or more devices via the AIoT interface. The WTRU may transmit the determined D2R transmission parameters and/or resources via an inventory procedure (e.g., initial paging message and/or AIoT configuration message) and/or a command procedure (e.g., in a configuration for a command procedure) and/or a new type of AIoT operation/procedure.

In some embodiments, a device may determine D2R transmission parameters based on the received AS configuration from WTRU. In one example, a WTRU may determine and deliver the determined D2R transmission parameters to one or more devices. Upon receiving the D2R transmission parameters, the one or devices may perform D2R transmission, e.g., using amount of resources, performing re-access via an inventory procedure (e.g., RACH procedure) and/or may perform a command procedure (e.g., retransmission for command message) based on the received D2R transmission parameters (e.g., determined D2R transmission with required QoS levels).

A WTRU may configure an AS configuration of D2R/R2D transmission parameters and associated specific resource based on the required/requested QoS levels. In one example, for supporting QoS levels of the AIoT operation with an AIoT data/request, R2D/D2R transmission parameters and Uu resources are based on one or more of factors (1)-(6) discussed below:

### (1) The Size/Amount/Number of Uu Resource:

In one example, a WTRU may be configured the number of access occasions (e.g., Q value) for RACH procedure in an inventory procedure. For example, when the requested number of the device (e.g., a list of device ID(s)/a range of device ID(s)/a group ID(s)) associated with the (re-)transmissions of the message and/or inventory procedure.

In one example, a WTRU may be configured with size and/or amount and/or number of Uu resource for specific AIoT operation. For example, the specific size and/or amount of Uu resource may comprise at least one of time and/or frequency resource (e.g., NR bandwidth/sub-band/resource blocks/time slots). For example, the size and/or amount of Uu resource can be used and associated (one of) inventory procedure and/or (one of) command procedure.

### (2) The Number of (Re-)Transmissions:

In one example, a WTRU may be configured with the number of a specific message for the inventory procedure (e.g., initial paging and/or initial query). For example, when the requested number of the device (e.g., a list of device ID(s)/a range of device ID(s)/a group ID(s)) associated with the (re-)transmissions of the message and/or inventory procedure.

In one example, a WTRU may be configured the number of a specific message for the inventory procedure (e.g., MSG2 in RACH procedure). For example, when the requested number of the device (e.g., a list of device ID(s)/a range of device ID(s)/a group ID(s)) and when the requested service types and QoS levels (e.g., latency sensitive and/or QoS profiles) associated with the (re-)transmissions of MSG2 in RACH procedure.

In one example, a device may be configured the number with a message/signaling for the inventory and/or command procedure. For example, maximum number of (re-)transmission is configured in RACH procedure (e.g., MSG1 and/or MSG3). For example, maximum number of (re-)transmission is configured with at least one of the commands for AIoT operation (e.g., read/write).

### (3) The Response Time (e.g., Minimum/Maximum Time Duration/Time Window):

In one example, a WTRU may be configured with a response time (e.g., transmit time for MSG2) upon receiving the MSG1 from the device.

In one example, a WTRU may be configured with a response time (e.g., response time for command message, (re-)transmission time for command) upon receiving request or NACK from the device.

In one example, a device may be configured with a response time (e.g., transmitting time for MSG3) upon receiving the MSG2 from the reader. In one example, a device may be configured with a response time (e.g., transmitting time for MSG4 or subsequent MSG) upon receiving the MSG3 or NACK from the reader.

In one example, the maximum/minimum response time for AIoT interface may comprise at least one of time resource (e.g., time slots/subframes/msecs/secs).

### (4) The Transmission Power (e.g., Minimum/Maximum Power):

In one example, a WTRU may be configured with the maximum/minimum transmission power (e.g., transmission power for MSG2, initial paging message, (re-)transmission for paging message) associated with an inventory procedure (e.g., RACH/paging).

In one example, a WTRU may be configured with the maximum/minimum transmission power associated with a command procedure (e.g., read/writer commands).

In one example, a device may be configured with the maximum/minimum transmission power (e.g., transmission power for MSG1/MSG3) associated with an inventory procedure (e.g., RACH).

In one example, a device may be configured with the maximum/minimum transmission power associated with a command procedure (e.g., read/writer command).

In one example, the maximum/minimum transmission power may be configured with initial transmission and (re-)transmissions, separately. For example, increased power level may be configured based on the sequence of (re-)transmissions.

### (5) The Random Access Type:

In one example, a WTRU may be configured with perform a contention-free RACH procedure or contention-based RACH procedure for one or more devices based on the QoS levels.

In one example, a WTRU may be configured with a specific number of preambles for RACH procedure for one or more devices based on the QoS levels.

In one example, a device may be configured with perform the 2-step or 3-step RACH procedure based on the QoS levels.

(6) The Re-Access Time for RACH procedure Based on QoS Levels:

In one example, a device may be configured to perform re-access transmissions (e.g., MSG1 and/or MSG3) in the same access round. For example, the device may be configured to perform re-access with the same or different access occasion(s) within the same access round.

In one example, a device may be configured to perform re-access transmissions (e.g., MSG1 and/or MSG3) in the different/next access round.

In one example, a device may be configured to perform re-access transmissions (e.g., MSG1 and/or MSG3) in the same paging round. For example, the device may be configured to perform re-access in the same or different access round within the same paging round.

In one example, a device may be configured to perform re-access transmissions (e.g., MSG1 and/or MSG3) in the next paging round (e.g., subsequent paging message).

In one example, a device may be configured to perform re-access transmissions (e.g., MSG1 and/or MSG3) in the next (or subsequent) DL signal (e.g., sync signal, query signal).

Combinations of the above factors are also possible, e.g., one or another condition being satisfied, multiple conditions being satisfied, a threshold for one condition being computed by another factor, etc.

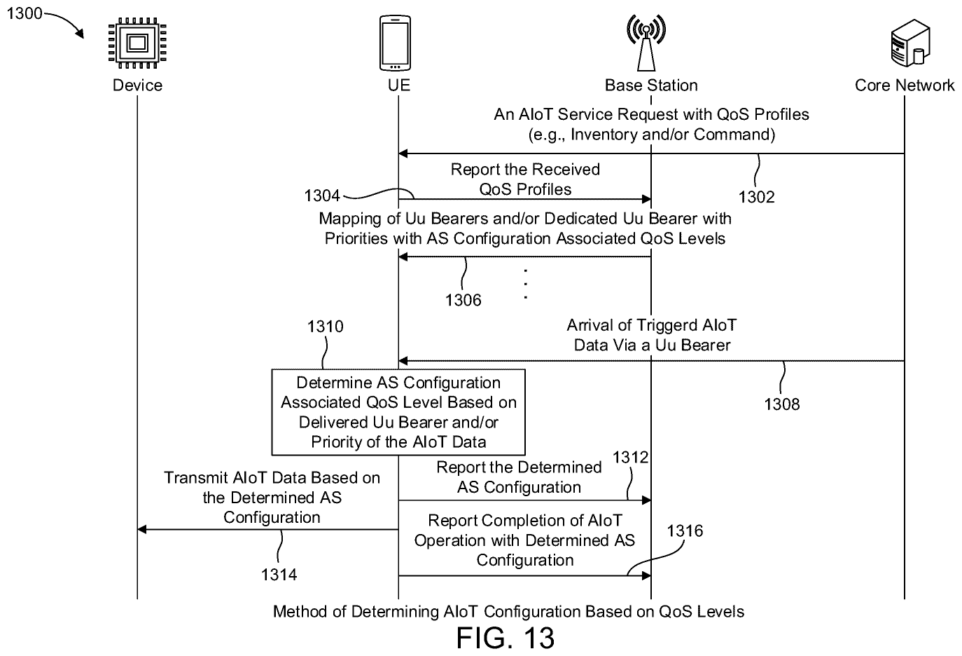

Referring to FIG. 13, a method 1300 of determining an AIoT configuration based on QoS levels according to an example first embodiment is shown. Entities involved in example method 1300 may include one or more AIoT devices (shown as a single device), a WTRU, a base station/RAN node and a core network (CN). In method 1300, the WTRU/UE/reader may receive 1302 an AIoT service request with QoS profiles from a network, e.g., the CN. The WTRU may report 1304 the received QoS profiles to the base station. Upon receiving the QoS profiles from the WTRU, the base station may determine and send 1306 back to the WTRU, a mapping configuration of Uu bearers and associated AS configurations and/or a mapping configuration of a dedicated Uu bearer with priorities and associated AS configurations. The AS configuration is associated with the QoS profile/levels and may include related Uu resources and/or R2D/D2R transmission parameters for the AIoT interface/operations.

When an AIoT data is triggered for inventory and/or command procedure, the triggered AIoT data is sent from CN and delivered 1308 to the WTRU via a Uu bearer from the base station. Upon receiving the triggered AIoT data via the Uu bearer, the WTRU may determine/select 1310 the AS configuration associated with a QoS level based on the Uu bearer from the previously received mapping configuration and/or when the AIoT data with priority involved the dedicated Uu bearer and indicated priority. Upon determining 1310 the AS configuration, the WTRU may report 1312 the determined AS configuration to the base station.

The WTRU may send 1314 a R2D transmission (or receive D2R transmission) with the arrived AIoT data for the associated inventory and/or command procedure based on the determined AS configuration. When the AIoT operation with the triggered AIoT data is completed, which may be at the sending the data to the AIoT device or depending on the AIoT operation, after a response is received from the AIoT device (not shown) the WTRU may report 1316 the completion of the AIoT operation and determined/used AS configuration to the base station.

Example benefits of this solution include enabling a WTRU to perform AIoT transmission for devices based on QoS levels of the AIoT data. When the AIoT data arrived via Uu interface, the WTRU may determine an appropriate AS configuration (e.g., amount of resource, R2D/D2R transmission parameters) for the triggered AIoT operation. Additionally, the WTRU may indicate when to (de-)activate the determined AS configuration.

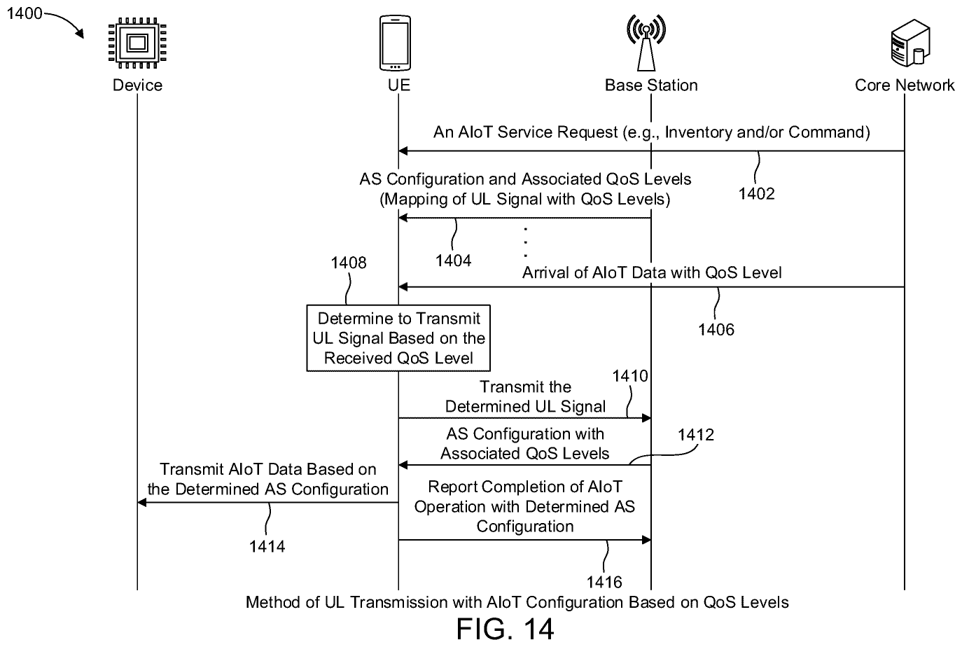

Referring to FIG. 14, a method 1400 of uplink (UL) transmission with AIoT configuration based on QoS levels according to an example second embodiment is shown. Entities involved in example method 1400 are similar to the previous embodiment. In method 1400, the WTRU/UE/reader may receive 1402 an AIoT service request from the core network. The base station may determine and send 1404 to the WTRU, a mapping configuration of UL signals, e.g., a list and AS configurations with respective QoS profiles/levels corresponding to the list of UL signals. Each AS configuration associated with the QoS profile may include/indicate a Uu resource and/or R2D/D2R transmission parameters for the AIoT interface. Steps 1402 and 1404 may be performed in any order.

When an AIoT data with QoS level is triggered for an inventory and/or command procedure, the triggered AIoT data is transmitted from CN (via base station) and delivered 1406 to the WTRU. Upon receiving the triggered AIoT data with QoS level, the WTRU may determine 1408 and send 1410 the configured UL signal associated with the QoS level corresponding to an AS configuration. In response to sending 1410 the UL signal, the base station sends and the WTRU may receive 1412 an AS configuration for AIoT interface associated QoS level.

The WTRU may then send 1414 an R2D transmission (or receive a D2R transmission) with arrived AIoT data associated with an inventory and/or a command procedure based on the determined AS configuration. When the AIoT operation with the triggered AIoT data is completed, the WTRU may report 1416 the completion of the AIoT operation and determined/used AS configuration to the base station.

Example details and/or examples related to method 1400 of FIG. 14 may include factors (1) and (2) discussed below.

(1) Determining transmission of the UL signal: In these solution embodiments, a WTRU may receive or be configured with a list of AS configurations for one or more AIoT operations, e.g., using the AIoT interface. Each of the AS configurations may be associated with at least one of the QoS level (e.g., QoS profile) for a specific AIoT operation. In one example, the AS configuration may be associated with an inventory procedure and/or a command procedure. In one example, each AS configuration may be associated/configured/valid with one or more inventory rounds (e.g., association with a specific round and/or specific rounds).

In one example, a WTRU may receive a mapping configuration of UL signals (e.g., scheduling request (SR)/uplink control information (UCI)/buffer status report (BSR)/RRC message) and a respective AS configuration associated with a QoS level, from base station. For example, each of the UL signals may be associated at least one of the QoS levels. In an example, each of the AS configurations may be associated with at least one of the QoS levels. When at least one AIoT data with a QoS level for an inventory or command procedure arrives, the WTRU may determine to transmit the UL signal associated with/mapped to the indicated QoS level.

(2) Mapping with UL signals and associated AS configuration: In one example, a WTRU may be configured with a list of UL signals (e.g., dedicated and/or shared) and associated AS configurations with QoS levels. For example, the list of UL signals may include a message, e.g., SR/UCI/BSR/CG/RRC message. For example, at least one of the UL signals may be mapped/indicated with at least one of the AS configurations. For example, at least one of the AS configurations may be mapped/indicated with at least one of the QoS levels.

In one example, a WTRU may be configured with a list of UL signals (e.g., dedicated and/or shared) and AS configurations with QoS levels corresponding to each UL signal. For example, the list of UL signals may include an indicated number of preamble(s) for a RACH procedure. As one example, at least one of the UL signals may be mapped/indicated with at least one of the AS configurations. For example, at least one of the AS configurations may be mapped/indicated with at least one of the preambles for RACH procedure.

As another example, a WTRU may be configured with one or more bits and associated AS configuration with QoS levels. For example, each of bit may be mapped/indicated with at least one of the AS configurations.

In another example, a WTRU may be configured with one or more indices configuration (e.g., bitmap, codepoints) and an associated AS configuration with QoS levels. For example, each of the index configuration may be mapped/indicated with at least one of the AS configurations.

In one example, one of the UL signals with high priority (e.g., low latency, high reliability) may be mapped associated AS configuration with D2R/R2D transmission parameters and resource based on the requested high QoS levels. For example, the QoS level is associated with a required completion time for inventory and/or command procedure.

In one example, one of the UL signals with low priority (e.g., latency tolerant, low reliability) may be mapped to an associated AS configuration with D2R/R2D transmission parameters and resource based on the requested low QoS levels. For example, the QoS level is associated with a required completion time for an inventory and/or command procedure.

In one solution, upon receiving an AIoT data with at least one QoS level, a WTRU may determine to transmit the configured UL signal (i.e., an indication of an AS configuration with QoS level) based on the received mapping configuration of UL signals and QoS levels.

In one solution, a WTRU may transmit one UL signal indicating an associated AS configuration, then the WTRU may receive the AS configuration with QoS levels.

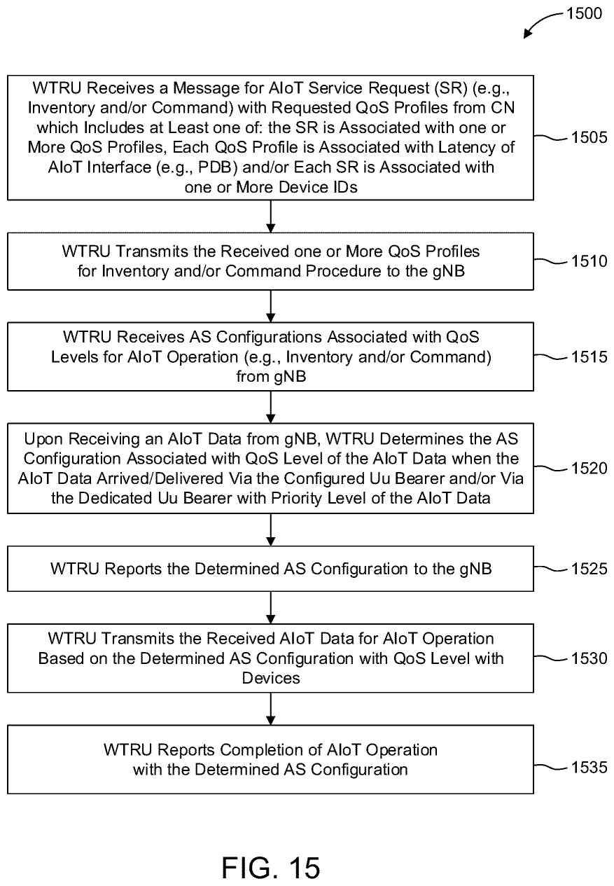

Referring to FIG. 15, a method 1500 for use by a WTRU to determine and AIoT configuration based on QoS levels according to one example embodiment is shown. Generally, in this embodiment, a WTRU determines AIoT resource and transmission parameters with a QoS level based on the configured bearer and/or priority associated received AIoT data.

FIG. 15 method 1500 may begin by the WTRU receiving 1505 a message for AIoT service request (e.g., an inventory and/or a command) with requested QoS profiles from the CN. In an example, the AIoT service request includes at least one of: (i) one or more QoS profiles associated with the requested AIoT operation (e.g., initial paging, query); (ii) each QoS profile is associated with latency of the AIoT interface (e.g., PDB); and/or (iii) each service request is associated with one or more device IDs.

At step 1510, the WTRU sends/transmits the received the one or more QoS profiles for the inventory and/or command procedure(s) to the gNB. The WTRU receives 1515 from the gNB, configuration information including one or more AS configurations where each AS configuration is associated with a QoS level specific to an AIoT operation or procedure (e.g., inventory and/or command). In one example, the configuration information includes a mapping of one or more Uu bearers for each AS configuration with QoS levels. In some examples, each AS configuration is associated with resource and transmission parameters for AIoT operation. In another example, Indication of a dedicated Uu bearer with priorities of AIoT data where each indicated priority (e.g., high) is associated with resource and transmission parameters for AIoT operation, e.g., R2D transmission. The following are examples of resource and/or transmission parameters for the AIoT interface: (i) An amount of dedicated Uu resource; (ii) an amount of access occasions (e.g., Q value); (iii) a number of retransmissions (e.g., paging); (iv) a maximum transmission power for (re-)transmissions; (v) maximum/minimum R2D waiting time (e.g., MSG2 for RACH); and/or (vi) maximum/minimum D2R waiting time.

Next, the WTRU receives AIoT data for an AIoT procedure (e.g., inventory and/or command procedure) from the gNB via a Uu bearer (e.g., from the CN via the gNB) and based on the Uu bearer (i.e., via the configured Uu bearer and/or via the dedicated Uu bearer with priority level), the WTRU determines 1520 an AS configuration with associated QoS level to use for transmitting 1530 the received AIoT data to the device. In certain embodiments, the WTRU may report 1525 the AS configuration upon its determination by the WTRU to the gNB and/or report 1535 completion of the AIoT procedure with the determined AS configuration, e.g., after transmission of the AIoT data or receiving data from the device in a response.

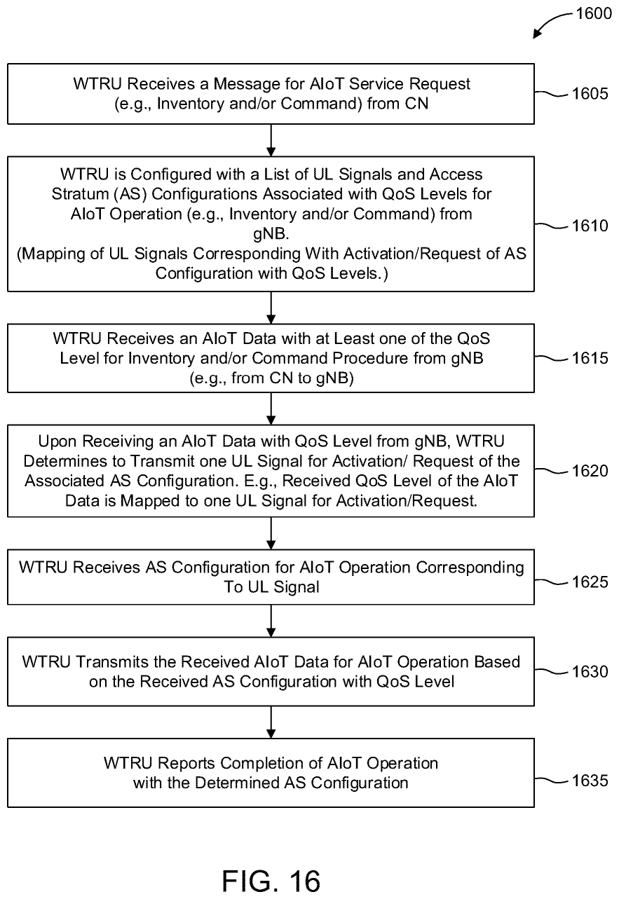

Referring to FIG. 16, a method 1600 for use by a WTRU is shown to send an UL transmission to request and/or activate an AIoT configuration based on QoS according to one example embodiment. Generally, in this embodiment, upon receiving the AIoT data with associated QoS profile, a WTRU determines to transmit an UL signal to receive/activate an AS configuration for an AIoT operation based on one or more QoS levels.

FIG. 16 method 1600 may begin by the WTRU receiving 1605 a message for an AIoT service request (e.g., an inventory and/or a command) with requested QoS profiles from the CN (via the base station/gNB). The WTRU receives 1610 from the gNB, configuration information indicating a list of UL signals, a list of access stratum (AS) configurations each associated with a quality of service (QoS) level associated with QoS profiles specific to each of the one or more AIoT operations and a mapping of the list of UL signals to request and activate a respective AS configuration for AIoT operation (e.g., inventory and/or command). Examples of the configuration include mapping of each UL signal, such as SR/UCI/BSR/configured grant (CG)/RRC message and associated AS configurations, index of RACH preambles and associated AS configuration and/or simple indication (e.g., 1 bit) and associated AS configurations.

The WTRU receives 1615 an AIoT data with at least one of the QoS profile for an inventory and/or command procedure from the gNB (e.g., from the CN via the gNB). Upon receiving the AIoT data with QoS profile from the CN, the WTRU determines 1620 a select AS configuration and a corresponding UL signal from the configuration information and transmits the corresponding UL signal for activation/request of the select AS configuration. For example, the associated QoS level/profile of the received AIoT data is mapped one UL signal for activation/request.

In response to sending/transmitting the UL signal activation/request of the select AS configuration, the WTRU receives 1625 the requested/activated AS configuration for the AIoT operation from the gNB and uses the receive/activated AS configuration to transmit 1630 the AIoT data to the device. Lastly, the WTRU reports 1635 completion of the requested AIoT operation to the gNB, e.g., after successful transmission of the data or after receiving a response from the AIoT device for the operation.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use by a wireless transmit receive unit (WTRU), the method comprising:
receiving, from a base station, configuration information including a plurality of access stratum (AS) configurations, wherein each AS configuration is associated with a respective quality of service (QoS) level specific to an ambient internet of things (AIoT) operation;
receiving, on a Uu bearer from the base station, data for at least one AIoT device;
based on the Uu bearer of the received data, determining a select AS configuration with associated QoS level from the plurality of AS configurations; and
transmitting the received data to the at least one AIoT device using resource and transmission parameters of the select AS configuration with associated QoS level.

2. The method of claim 1, wherein the configuration information includes a mapping of one or more Uu bearers for each AS configuration and associated QoS level specific to each AIoT operation.

3. The method of claim 1, wherein the configuration information includes an indication of one or more dedicated Uu bearers associated with a respective priority of the received data.

4. The method of claim 3, wherein the respective priority of the received data is associated with resource and transmission parameters for a specific AIoT operation and based on at least one of: an amount of dedicated Uu resource of the received data, an amount of access occasions for the at least one AIoT device, a number of retransmissions for the at least one AIoT device, a maximum power for transmitting or retransmitting to the at least one AIoT device, or a maximum or minimum reader-to-device (R2D) waiting time or device-to-reader (D2R) waiting time for subsequent message transmission or reception.

5. The method of claim 1, further comprising, prior to receiving the configuration information:
receiving, via the base station, a message from a core network (CN) for an AIoT service request with requested QoS profiles including one or more of: an association of the AIoT service request with one or more QoS profiles, each QoS profile is associated with a packet delay budget of an AIoT interface, or the AIoT service request is associated with one or more device IDs; and
sending, to the base station, the one or more QoS profiles for at least one of an inventory procedure or a command procedure for the at least one AIoT device based on the received message from the CN.

6. The method of claim 5, wherein subsequent to receiving the configuration information, the method further comprises:
reporting, to the base station, the select AS configuration to activate with associated QoS level determined by the WTRU; and
reporting, to the base station, completion of an AIoT operation with the select AS configuration after transmitting the received data to the at least one AIoT device or receiving a response from the at least on AIoT device.

7. A wireless transmit receive unit (WTRU) comprising:
a transceiver and a processor operatively coupled to the transceiver, the transceiver and the processor configured to:
receive, from a base station, configuration information including a plurality of access stratum (AS) configurations, wherein each AS configuration is associated with a respective quality of service (QoS) level specific to an ambient internet of things (AIoT) operation;
receive, on a Uu bearer from the base station, data for at least one AIoT device;
based on the Uu bearer of the received data, determine a select AS configuration with associated QoS level from the plurality of AS configurations; and
transmit the received data to the at least one AIoT device using resource and transmission parameters of the select AS configuration with associated QoS level.

8. The WTRU of claim 7, wherein the configuration information includes a mapping of one or more Uu bearers for each AS configuration and associated QoS level specific to each AIoT operation.

9. The WTRU of claim 7, wherein the configuration information includes an indication of one or more dedicated Uu bearers associated with a respective priority of the received data.

10. The WTRU of claim 9, wherein the respective priority of the received data is associated with resource and transmission parameters for a specific AIoT operation and based on at least one of: an amount of dedicated Uu resource of the received data, an amount of access occasions for the at least one AIoT device, a number of retransmissions for the at least one AIoT device, a maximum power for transmitting or retransmitting to the at least one AIoT device, a maximum or minimum reader-to-device (R2D) waiting time or a maximum or minimum device-to-reader (D2R) waiting time for a subsequent message transmission or reception.

11. The WTRU of claim 7, wherein prior to receiving the configuration information, the transceiver and the processor are further configured to:
receive, via the base station, a message from a core network (CN) for an AIoT service request with requested QoS profiles including one or more of: an association of the AIoT service request with one or more QoS profiles, each QoS profile is associated with a packet delay budget of an AIoT interface, or the AIoT service request is associated with one or more device IDs; and
send, to the base station, the one or more QoS profiles for at least one of an inventory procedure or a command procedure for the at least one AIoT device based on the received message from the CN.

12. The WTRU of claim 11, wherein subsequent to receiving the configuration information, the transceiver and the processor are further configured to:
report, to the base station, the select AS configuration to activate with associated QoS level determined by the WTRU; and
report, to the base station, completion of an AIoT operation with the select AS configuration after transmitting the received data to the at least one AIoT device or receiving a response from the at least on AIoT device.

13. A method for use by a wireless transmit receive unit (WTRU), the method comprising:
receiving, from a core network (CN) via a base station, a message for an ambient internet of things (AIoT) service request to perform an AIoT operation with one or more requested quality of service (QoS) profiles;
receiving, from the base station, configuration information including a list of uplink (UL) signals, a list of access stratum (AS) configurations each having a quality of service (QoS) level associated with a QoS profile specific to each of a plurality of AIoT operations and a mapping of the list of UL signals to request a respective AS configuration;
receiving, from the CN via the base station, data with a specific QoS profile for at least one AIoT device for performing the AIoT operation;
based on the received data with the QoS profile, determining a select AS configuration and a corresponding UL signal;
sending, to the base station, the corresponding UL signal to request and activate the select AS configuration;
in response to sending the corresponding UL signal, receiving, from the base station, the select AS configuration for performing AIoT operation; and
sending, to the at least one AIoT device, the received data with the QoS level based on the select AS configuration.

14. The method of claim 13, wherein the AIoT operation comprises one of an inventory procedure or a command procedure with the at least one AIoT device.

15. The method of claim 13, wherein the mapping of the list of UL signals to request the respective AS configuration includes signaling for one of a scheduling request (SR), uplink control information (UCI), buffer status report (BSR), configured grant (CG) or a radio resource control (RRC) message and an associated AS configuration.

16. The method of claim 13, wherein the mapping of the list of UL signals to request the respective AS configuration includes signaling for an index of a random access channel (RACH) preamble and an associated AS configuration.

17. The method of claim 13, wherein the mapping of the list of UL signals to request the respective AS configuration includes signaling of an indication and an associated AS configuration.

18. The method of claim 13, further comprising:
subsequent to the sending, to the at least one AIoT device, the received data with the QoS level or receiving a response from the at least one AIoT device, reporting, to the base station, completion of the AIoT operation.

19. The method of claim 13, further comprising:
sending, to the at least one AIoT device, indication of the select AS configuration.

20. The method of claim 19, further comprising:
receiving, from the at least one AIoT device, a response based on the indication of the select AS configuration.
